(19) United States
(12) Patent Application Publication
(10) Pub. No.: US 2009/0000677 A1
(43) Pub. Date: Jan. 1, 2009

(54) Oil pressure control device having a damper for suppressing pressure dither

(75) Inventors: Yoshitsugu Inaguma, Chita-gun (JP); Ryo Ishibashi, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/073,512

(22) Filed: Mar. 6, 2008

(30) Foreign Application Priority Data
Jun. 29, 2007 (JP) 2007-172115

(51) Int. Cl. F16K 31/00

(52) U.S. Cl. 137/624.27

(57) ABSTRACT

An oil pressure control device of the present invention is used for controlling oil pressure supplied to an automatic transmission device for an automotive vehicle. The oil pressure control device includes two or more spool valves driven by electromagnetic actuators. A spool forming the spool valve is slidably disposed in a cylindrical hole formed in a valve body. An oil-damper chamber is connected to an axial end of the cylindrical hole to suppress micro-vibrations of the spool caused by driving frequencies of the electromagnetic actuator. An oil-retaining space common to all the oil-damper chambers is formed in the valve case above the oil-damper chambers. Each oil-damper chamber is connected to the common oil-retaining space through an orifice. The oil-damper chamber and the orifice are filled with damper oil, and thereby the micro-vibrations of the spool are effectively suppressed.

### CROSS-REFERENCE TO RELATED APPLICATION

This application is based upon and claims benefit of priority of Japanese Patent Application No. 2007-172115 filed on Jun. 29, 2007, the content of which is incorporated herein by reference.

### BACKGROUND OF THE INVENTION

1. Field of the Invention

The present invention relates to an oil pressure control device including an oil-damper chamber for suppressing dither in controlled oil pressure. The oil pressure control device is used, for example, in an automatic transmission device mounted on an automotive vehicle.

2. Description of Related Art

A spool valve has been often used in an oil pressure control valve for an automatic transmission device mounted on an automotive vehicle. The spool valve is slidably disposed in a cylindrical hole formed in a valve body and is driven by an electromagnetic actuator or oil actuators. The oil pressure control valve controls oil pressure supplied to the automatic transmission device.

Small vibrations (dither) due to frequencies in voltages for driving the spool valve are transmitted to the spool valve, and oil pressure controlled by the spool valve vibrates according to the small vibrations of the spool valve. Some proposals have made for preventing or suppressing the small vibrations in the spool valve by using an oil damper, as exemplified in the following documents: JP-A-2002-130513; JP-U-63-159410; JP-A-2005-121069; and JP-A-2006-307941.

An example of a conventional oil pressure control valve having an oil damper is shown in FIGS. 6A and 6B attached thereto. An oil-damper chamber 26, a volume of which changes according to movement of a spool 5, is filled with oil and is connected to an oil-retaining space 42 through an orifice 41. The orifice 41 is positioned lower than an oil level in a drain pipe 101. In this manner, speed of volume changes in the oil-damper chamber 26 is reduced, thereby suppressing vibrations of the spool 5.

The oil-damper chamber 26 has to be filled with oil because damping effects are reduced if air is contained in the oil-damper chamber 26. In the conventional oil pressure control valve, the oil-damper chamber 26 is filled with oil in the following manner: (a) the orifice 41 is connected to the oil-damper chamber 26 at its upper portion; (b) the oil-retaining space 42 is positioned at a lateral side of the oil-damper chamber 26; (c) the orifice 41 is adapted to communicate with the oil-retaining space 42; and (d) an upper opening of a drain pipe 101, which connects the oil-retaining space 42 to an oil pan 100, is positioned above the orifice 41, thereby positioning an oil level of the oil-retaining space 42 above the orifice.

As described above, a problem that a damper oil passage from the oil-retaining space 42 to the oil pan 100 becomes complex, is involved in the conventional oil pressure control valve. Especially, in a case where plural spools each having an oil-damper chamber are formed in the valve housing 2, the complex damper oil passage has to be formed for each spool. This makes the width of the valve body 2 wide, and makes the oil pressure control valve bulky and heavy. It is not easy to mount a bulky and heavy oil pressure control valve on an automobile.

### SUMMARY OF THE INVENTION

The present invention has been made in view of the above-mentioned problem, and an object of the present invention is to provide an improved oil pressure control device, in which a single damper oil passage common to plural spool valves is provided, avoiding increase in size and weight of the control device.

The oil pressure control device is used for controlling oil pressure supplied to an automatic transmission device mounted on an automotive vehicle, for example. The oil pressure control device is mounted on an upper surface of a case containing the automatic transmission device therein (referred to as an AT case). The upper surface of the AT case is substantially horizontal. The oil pressure control valve includes a valve body, two or more spool valves formed in the valve body, and electromagnetic actuators for driving the spool valves.

Each spool valve has a spool slidably disposed in a cylindrical hole formed in the valve body. At an axial end of the cylindrical hole, an oil-damper chamber for suppressing micro-vibrations (dither) of the spool due to driving frequencies of the electromagnetic actuator is connected. An oil retaining space common to all of the oil-damper chambers is formed in the valve body in a horizontal direction above the oil-damper chambers. Each oil-damper chamber is connected to the oil-retaining space through an orifice. The oil in the oil-damper chamber is returned to an oil pan in the AT case through the orifice, the oil-retaining space and a drain passage formed in the valve case.

Since the oil-retaining space is common to all of the oil-damper chambers, the valve case can be made compact. Since the oil-retaining space is positioned above the oil-damper chambers, air entered into the oil-damper chambers is easily pushed up into the oil-retaining space. Therefore, the oil-damper chambers and the orifices are filled with oil thereby to enhance damping effects. Since the oil-retaining space formed in the horizontal direction in the valve body is positioned close to the oil-damper chamber, a breathing hole including the orifice connecting the oil-retaining space and the oil-damper chamber can be easily made by drilling in the vertical direction.

The oil-retaining space may be formed by drilling from a side of the valve body in the horizontal direction. The breathing hole may be formed by drilling from either an upper surface or a bottom surface of the valve body in the vertical direction. The oil-retaining space may be formed in a shape of a sloped transversal hole to make the oil level in the oil-retaining space higher. It is also possible to mount the oil pressure control device on a sloped surface of the AT case to position an outlet end of the oil-retaining space higher.

According to the present invention, micro-vibrations (dither) of the oil pressure are effectively suppressed without enlarging a size of the oil pressure control device. Other objects and features of the present invention will become more readily apparent from a better understanding of the preferred embodiments described below with reference to the following drawings.

### BRIEF DESCRIPTION OF THE DRAWINGS

FIG. 1A is a plan view showing an oil pressure control device as a first embodiment of the present invention;

FIG. 1B is a cross-sectional view showing the oil pressure control device, taken along line IB-IB shown in FIG. 1A;

FIG. 2 is a cross-sectional view showing an oil pressure control valve used in the oil pressure control device, taken along line II-II shown in FIG. 1A;

FIG. 3 is a cross-sectional view showing an oil pressure control device as a second embodiment of the present invention;

FIG. 4 is a cross-sectional view showing an oil pressure control device as a third embodiment of the present invention;

FIG. 5 is a cross-sectional view showing an oil pressure control device as a fourth embodiment of the present invention;

FIG. 6A is a cross-sectional view showing a conventional oil pressure control valve; and

FIG. 6B is a cross-sectional view showing the conventional oil pressure control valve, taken along line VIB-VIB shown in FIG. 6A.

### DETAILED DESCRIPTION OF THE PREFERRED EMBODIMENTS

In the preferred embodiments described below, the present invention is applied to an oil pressure control device for supplying oil to an automatic transmission device mounted on an automotive vehicle. The oil pressure control device includes plural spool valves each having an oil-damper chamber and a damper oil passage common to all of the oil-damper chambers. A bottom surface of the oil pressure control device is connected to an upper surface of a case containing the automatic transmission device (referred to as an AT case).

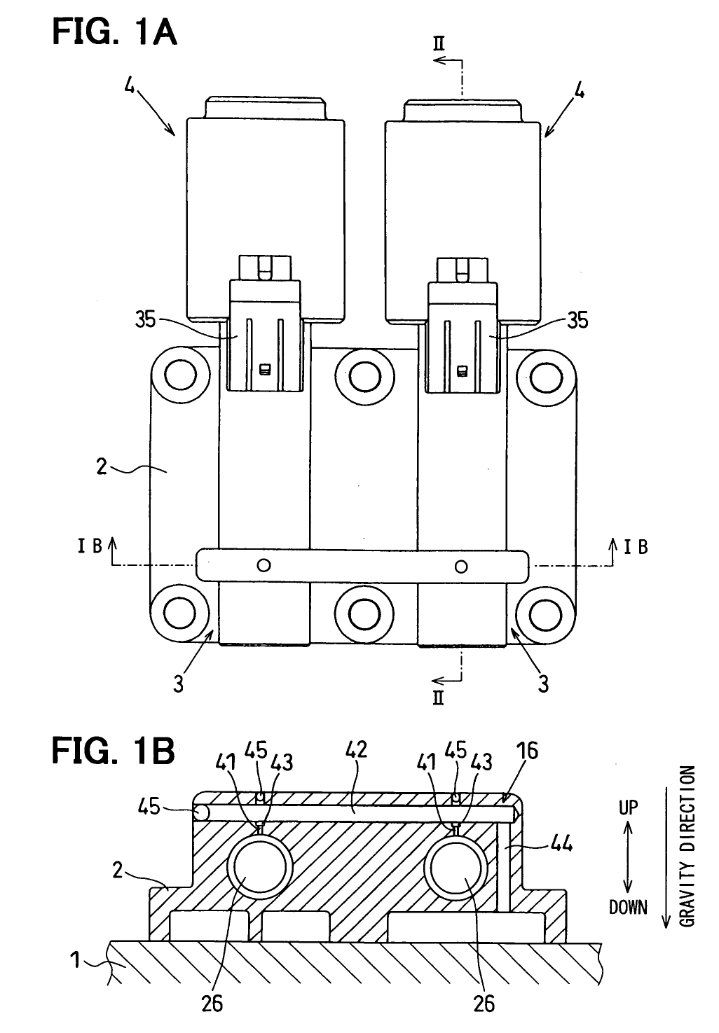

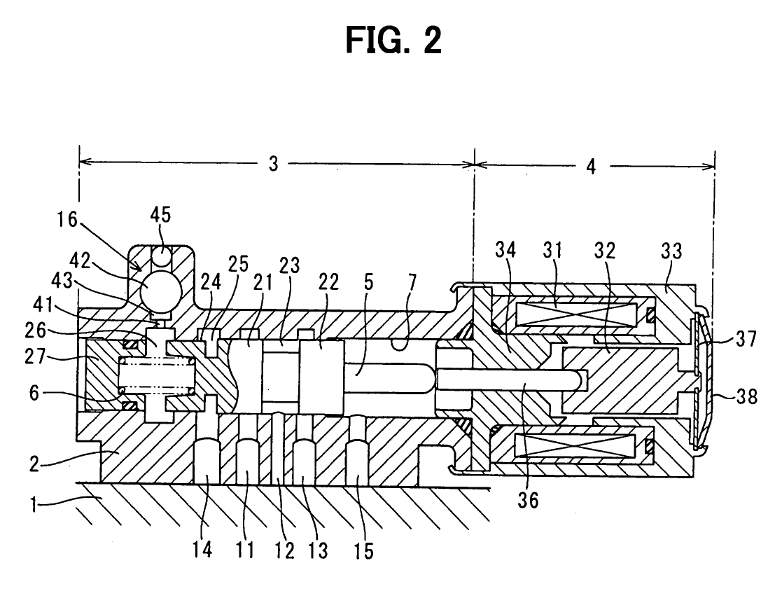

A first embodiment of the present invention will be described with reference to FIGS. 1A, 1B and 2. The automatic transmission device mounted on an automotive vehicle includes various friction-operated components which are controlled by oil supplied from the oil pressure control device. The oil pressure control device controls pressure of the oil to be supplied to the automatic transmission device according to control signals fed from an electronic control unit for an automatic transmission (AT-ECU).

As shown in FIGS. 1A and 1B, the oil pressure control device is mounted on the AT case 1 having an upper surface which is substantially perpendicular to the direction of gravity. The oil pressure control device includes two oil pressure control valves each composed of a spool valve 3 and an electromagnetic actuator 4. The oil pressure control valve 3 and the electromagnetic actuator 4 are shown in FIG. 2. The spool valve 3 includes a cylindrical hole 7 formed in a valve body 2, a spool 5 slidably disposed in the cylindrical hole 7, a return spring 6 biasing the spool 7 to a direction to close the valve, and an oil-damper chamber 26 formed at an axial end of the spool 7. The spool 5 is driven by the electromagnetic actuator 4. In this particular embodiment, the spool valve 3 is a normally closed valve which is closed when the electromagnetic actuator 4 is not energized, or a normally low valve, in which output oil pressure is low when the electromagnetic actuator 4 is not energized. A bottom surface of the valve body 2 is connected to an upper surface of the AT case by bolts, thereby fixedly mounting the oil pressure control device on the AT case.

As shown in FIG. 2, the spool 5 is disposed in the cylindrical hole 7 formed in the valve body 2 so that the spool 5 sildably moves in the axial direction of the cylindrical hole 7. In the valve body 2, an inlet port 11, an outlet port 12, an exhaust port 13, a feed-back port 14 and a breathing port 15 are formed. Further, a damper oil passage 16 including an oil-retaining space 42 and a drain passage 44 is formed in the valve body 2, as shown in FIG. 1B. Oil is supplied from an oil pump installed in the automatic transmission device to the inlet port 11. The outlet port 12 is connected to friction-operated components in the automatic transmission device. The exhaust port 13 communicates with an inside space or an oil pan of the automatic transmission device. The feed-back port 14 communicates with a feed-back chamber 25 (which will be explained later in detail). All the ports 11-15 communicate with an inside space of the cylindrical hole 7.

The feed-back port 14 also communicates with the output port 12 through an orifice (not shown) thereby to generate an output pressure in the feed-back chamber 25. The breathing port 15 communicates with the exhaust port 13 through a passage (not shown) formed in the valve body 2, thereby making possible a volume change in a drain space between the spool 5 and the electromagnetic actuator 4. The damper oil passage 16 is an oil passage for leading oil filling the oil-damper chamber 26 to an inside of the AT case.

As shown in FIG. 2, the spool 5 includes an inlet seal land 21 for sealing the inlet port 11 and an exhaust seal land 22 for sealing the exhaust port 13. An output chamber 23 always communicating with the outlet port 12 is formed between the inlet seal land 21 and the exhaust seal land 22. The spool 5 also includes a feed-back seal land 24 having a diameter smaller than that of the input seal land 21. The feed-back seal land 24 is formed at a left side end (in FIG. 2) of the spool 5. A feed-back chamber 25 is formed between the input seal land 21 and the feed-back seal land 24.

Since the feed-back chamber 25 communicates with the output port 12 through an orifice (not shown) as mentioned above, a feed-back pressure is generated in the feed-back chamber 25 according to the output pressure. As the feed-back pressure becomes high according to increase in the output pressure, “a feed-back pressure” is applied to the spool 5 in the direction to close the valve (rightward direction in FIG. 2). A displacement position of the spool 5 is stabilized by the feed-back pressure when the output pressure is generated, and changes in the output pressure in response to changes in the input pressure are suppressed.

The return spring 6 is a coil spring disposed in the oil-damper chamber 26 in a compressed state between the left side end of the spool 5 and an adjusting screw 27. The return spring applies “a biasing force” in the direction to close the valve (rightward direction in FIG. 2). The biasing force can be adjusted by turning the adjusting screw 27. The spool 5 is positioned in the cylindrical hole 7 at a position where a sum of “the feed back pressure” and “the biasing force” balances with the driving force of the electromagnetic actuator 4.

The electromagnetic actuator 4 is composed of a coil 31, a plunger 32, a yoke 33, a stator core 34 and a connector 35 (shown in FIG. 1A). The electromagnetic actuator 4 is energized by current supplied from the AT-ECU in a controlled manner. Upon energization of the electromagnetic actuator 4, the spool 5 is driven in the direction to open the valve (leftward direction in FIG. 2) against the biasing force of the return spring 26. The coil 31 is formed by winding an insulated wire around a resin bobbin. By supplying current to the coil 31, a magnetic flux is generated in a loop formed by the plunger 32, the stator core 34 and the yoke 33.

The plunger 32 is made of a magnetic material such as iron in a substantially cylindrical column shape. The plunger 32 is supported by a shaft 36 and a disk spring 37 so that the plunger 32 is movable in the axial direction. The shaft 36 is rod-shaped and is slidably supported in a center hole formed in the stator core 34. One end of the shaft 36 is fixedly connected to the plunger 32. An outer periphery of the disk spring 37 is connected to the right side end of the yoke 33 together with a cover 38 closing a right side opening of the yoke 33. The disk spring 37 is connected to a center projection formed on the plunger 32.

The yoke 33 is made of a magnetic material in a cylindrical shape. The yoke 33 includes an outer cylindrical portion covering the outside of the coil 31, an inner cylindrical portion facing the outer periphery of the plunger 32, and an end wall portion connecting the outer cylindrical portion and the inner cylindrical portion. A small magnetic gap, through which the magnetic flux flows, is formed between the outer periphery of the plunger 32 and the inner bore of the yoke 33. A claw is formed in a circular form at the left side end of the yoke 33. The spool valve 3 and the electromagnetic actuator 4 are firmly connected to each other by staking the claw after all the components are assembled in the spool valve 3 and in the electromagnetic actuator 4.

The stator core 34 is made of a magnetic material such as iron in a cylindrical shape having a flange that is engaged with an opening of the yoke 33. An air gap is formed between the plunger 32 and the stator core 34, and a portion of the stator core 34 facing the plunger 32 includes a V-shaped depression, so that a magnetic force attracting the plunger 32 toward the stator core 34 does not substantially change according a stroke of the plunger 32 in the axial direction.

The connector 35 (shown in FIG. 1A) is electrically connected to the coil 31, and electric current is supplied from the AT-ECU to the coil 31 in a controlled manner. An amount of current supplied to the coil is controlled in a duty-control. The spool 5 is driven to a desired position in the cylindrical hole 7 by controlling an amount of electric current supplied to the coil 31. Thus, the oil pressure supplied to the automatic transmission device is controlled.

Operation of the oil pressure control valve described above will be briefly explained. Upon energizing the electromagnetic actuator 4, the spool 5 moves leftward from the position shown in FIG. 2. As the plunger 5 moves leftward, the inlet port 11 sealed by the inlet seal land 21 is opened, and at the same time, the exhaust port 13 is closed by the exhaust seal land 22. This process is gradually performed, and pressure of the oil supplied to the automatic transmission device from the outlet port 12 increases. When the output pressure reaches a predetermined level, the friction-operated component in the automatic transmission device is brought to an engaging state. Upon establishing the engagement, the output oil pressure is rapidly increased by rapidly increasing the amount of current supplied to the electromagnetic actuator 4 thereby to strengthen the established engagement in the friction-operated component. To release the engagement, the oil pressure control valve is operated in a reversed manner.

The amount of current supplied to the electromagnetic actuator 4 is duty-controlled as mentioned above. Therefore, micro-vibrations (dither) due to a duty-frequency (e.g., about 250-300 Hz) are generated in the spool 5. If predominant micro-vibrations are generated in the spool 5, changes in the output oil pressure are generated, hindering a smooth engagement of the friction-operated components in the automatic transmission device. In order to suppress the micro-vibrations due to the duty frequency, a structure for damping the micro-vibrations of the spool 5 is provided in the oil pressure control valve.

The damping structure includes an oil-damper chamber 26, a capacity of which changes according to displacement of the spool 5, a damper oil passage 16 for returning oil in the oil-damper chamber 26 into the AT case, and an orifice 41 connecting the oil-damper chamber 26 to the damper oil passage 16. The orifice 41 is disposed close to the oil-damper chamber 26, and squeezes the cross-sectional area of the damper oil passage 16 thereby to slow down a flow speed of the oil and to slow down a displacement speed of the spool 5.

Referring to FIGS. 1A and 1B again, the damping structure including the oil-damper chamber 26, the damper oil passage 16, and the orifice 41 will be described. The damper oil passage 16 is composed of an oil-retaining space 42 that is connected to the oil-damper chamber 26 through the orifice 41 and a drain passage 44 for leading the damper oil into the AT case. Two spool valves are formed in the valve body 2, and one oil-retaining space 42 common to both oil-damper chambers 26 is formed in the valve body 2 above the oil-damper chambers 26. The oil pressure control device is mounted on the AT case, a posture of which is kept substantially unchanged with respect to the gravity direction.

The oil-retaining space 42 is connected to the oil-damper chamber 26 through a breathing hole 45 having the orifice 41 formed at its lower portion. The oil-retaining space 42 is a transversal hole formed in the valve body 2 by drilling operation. The oil-retaining space 42 extends transversally in the horizontal direction. An open end (the left side end in FIG. 1B) of the oil-retaining space 42 is closed with a plug 45 such as a ball plug, and its bottom end (the right side end in FIG. 1B) is connected to the drain passage 44.

The breathing hole 43 is formed in the valve body 2 by drilling from the upper surface of the valve body 2 in the vertical direction. At the bottom end of the breathing hole 43, the orifice 41 connected to the oil-damper chamber 26 is formed. The orifice 41 has a diameter smaller than that of the breathing hole 43. An upper end of the breathing hole 43 is closed with a plug 45 such as a ball plug. The drain passage 44 is formed by drilling the valve body 2 from its lower surface in the vertical direction. The drain passage 44 connected to the oil-retaining space 42 leads the damper oil to an oil pan in the automatic transmission device.

Advantages attained in the first embodiment described above will be summarized below. Oil leaked from the cylindrical hole 7 through a sliding clearance of the spool 5 enters the oil-damper chamber 26. The oil in the oil-damper chamber 26 is returned to the oil pan in the AT-case 1 through the breathing hole 43 including the orifice 41, the oil-retaining space 42 and the drain passage 44. If air enters the oil-damper chamber 26 in an assembling process of the device or in a process of maintenance, the air is pushed up and exhausted into the oil-retaining space 42 positioned above the oil-damper chamber 26. Thus, the oil-damper chamber 26 and the orifice 41 is surely filled with oil.

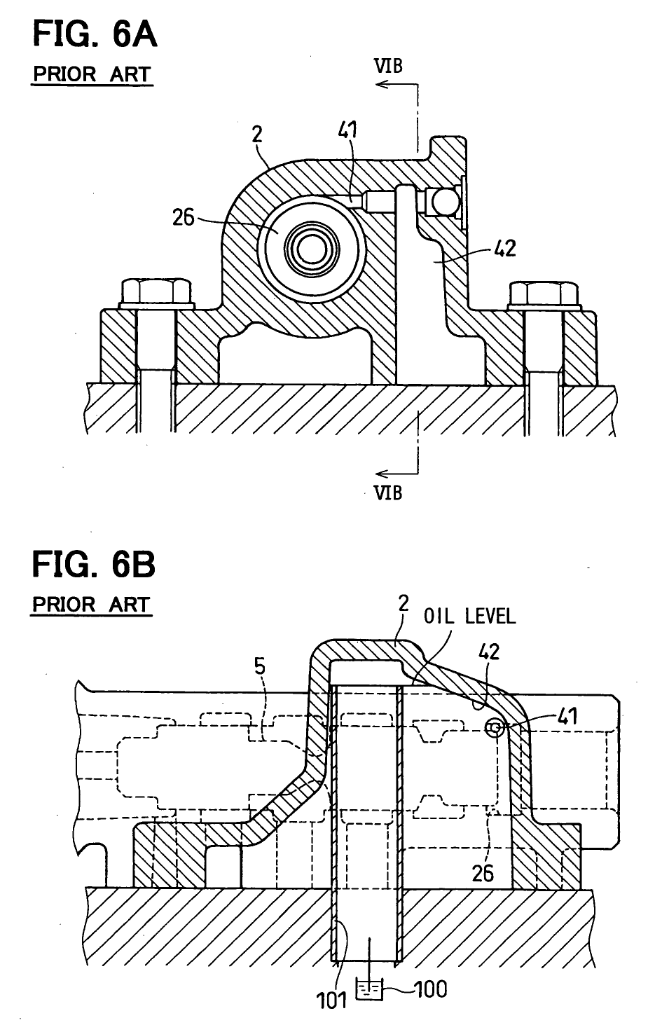

The oil-retaining space 42 is common to all of the oil-damper chambers 26 (two oil-damper chambers 26 are formed in this particular embodiment), and it is positioned above the oil-damper chambers 26. Therefore, a width of the valve body 2 can be made small, compared with the conventional device (an example shown in FIGS. 6A and 6B). Further, the oil pressure control device as a whole can be made compact and light in weight, and it can be easily mounted on the automatic transmission device.

The oil-retaining space 42 is a transversal hole made above the oil-damper chambers 26. Such transversal hole can be easily formed by drilling from a side of the valve body 2. Since the oil-retaining space 26 is positioned close to each oil-damper chamber 26, the breathing holes 43 including the orifice 41 can be easily formed by drilling the valve body 2 from its upper surface.

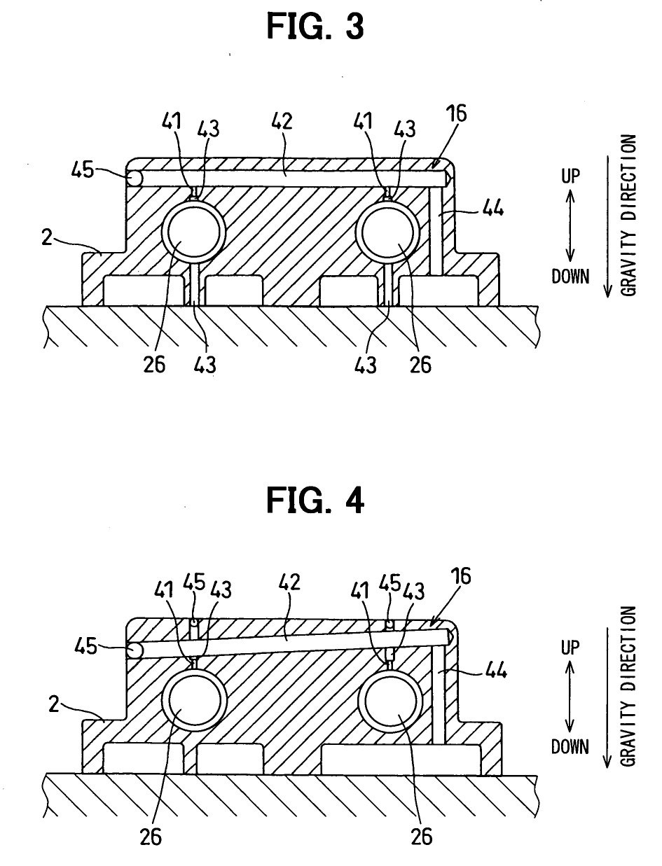

A second embodiment of the present invention is shown in FIG. 3. In this embodiment, the breathing hole 43 is formed by drilling the valve body 2 from its bottom surface to reach the oil-retaining space 42 through the oil-damper chamber 26. The orifice 41 having a smaller diameter is formed at the upper end of the breathing hole 43. The bottom opening of the breathing hole 43 is closed with the upper surface of the AT case 1. Accordingly, no plug for closing the bottom opening is required. Other structures and functions are the same as those of the first embodiment.

A third embodiment of the present invention is shown in FIG. 4. In this embodiment, the oil-retaining space 42 is sloped with respect to the bottom surface of the valve body 2. That is, its right side in FIG. 4 is higher than its left side. In this manner, an oil level in the oil-retaining space 42 can be made high, and thereby oil-damper chambers 26 and orifices 41 are surely filled with oil. Other structures and functions are the same as those of the first embodiment.

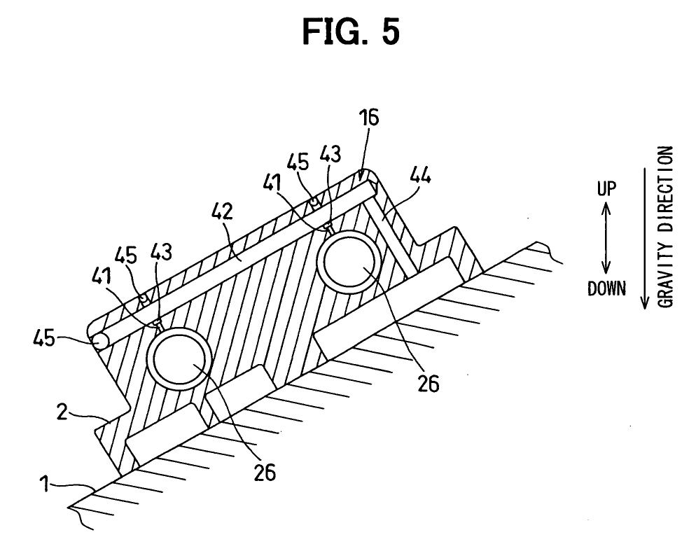

A fourth embodiment of the present invention is shown in FIG. 5. In this embodiment, the oil pressure control device is mounted on a sloped surface of the AT case 1. The right side end of the oil-retaining space 42 connected to the drain passage 44 is positioned higher than the left side end. In this manner, the oil-retaining space 42 can be sloped with respect to the horizontal direction without making the oil-retaining space slanted with respect to the valve body 2. The oil-damper chambers 26 and the orifices 41 are filled with oil without fail. Other structures and functions are the same as those of the first embodiment.

The present invention is not limited to the embodiments described above, but it maybe variously modified. For example, though the present invention is applied to the normally closed (or normally low) type control valve in the embodiments described above, it maybe applied to other types of valve such as a normally open or a normally high type valve. Though the spool valve 3 is driven by the electromagnetic actuator 4 in the above-described embodiments, the spool valve 3 may be driven by an output of a pilot valve (an electromagnetic three-way valve). Though the control valve is mounted on the upper surface of the AT case 1 in the foregoing embodiment, it is possible to install the valve device inside the AT case 1 (e.g., inside an oil pan). In this case, the drain passage 44 may be eliminated and the oil-retaining space 42 may be directly communicated with the inside space of the automatic transmission device.

Though the present invention is applied to a valve for controlling oil pressure in the foregoing embodiments, it may be applied to a valve for controlling an amount of oil. Though the spool valve 3 having a three-way valve structure is used in the foregoing embodiments, other spool valves, such as a two-way valve or a four-way valve, may be used in place of the three-way spool valve. The electromagnetic actuator 4 used in the foregoing embodiments may be replaced with other actuators such as a piezoelectric actuator, an electric motor, or a fluid-pressure actuator. The oil pressure control valve of the present invention may be used in other devices than the automatic transmission device.

While the present invention has been shown and described with reference to the foregoing preferred embodiments, it will be apparent to those skilled in the art that changes in form and detail may be made therein without departing from the scope of the invention as defined in the appended claims.

What is claimed is:

1. An oil pressure control device to be mounted on a structure, a posture of which is kept substantially unchanged with respect to a gravitational direction, the oil pressure control device comprising:
a valve body;
a plurality of oil pressure control valves formed in the valve body, each oil pressure control valve having a valve member that slidably moves in a cylindrical hole formed in the valve body;
an oil-damper chamber connected to an axial end of each of the cylindrical hole for damping movement of the valve member;
an oil-retaining space common to all of the oil-damper chambers, the oil-retaining space being formed in the valve body above the oil-damper chambers; and
an orifice connecting each oil-damper chamber to the oil-retaining space.

2. The oil pressure control valve as in claim 1, wherein the oil-retaining space is a transversal hole formed in the valve body in a horizontal direction.

3. The oil pressure control valve as in claim 2, wherein the transversal hole is formed across an upper portion of the oil-damper chambers.

4. The oil pressure control valve as in claim 3, wherein the transversal hole is sloped so that an oil outlet end thereof is positioned higher than the other end opposite to the oil outlet end with respect to a bottom surface of valve body.

5. The oil pressure control valve as in claim 4, wherein the transversal hole is inclined with respect to a bottom surface of the valve body.

6. The oil pressure control valve as in claim 3, wherein a bottom surface of the valve body is mounted on a surface of the structure that is inclined relative to a horizontal direction, so that an oil outlet end of the transversal hole is positioned higher than the other end opposite to the oil outlet end with respect to the horizontal direction.

7. The oil pressure control valve as in claim 2, wherein the transversal hole is connected to each oil-damper chamber through a breathing hole that is formed in a vertical direction from an upper surface of the valve body to the oil-damper chamber through the transversal hole, an upper end of the breathing hole being closed with a plug.

8. The oil pressure control valve as in claim 2, wherein the transversal hole is connected to each oil-damper chamber through a breathing hole that is formed in a vertical direction from a bottom surface of the valve body to the transversal hole through the oil-damper chamber, a bottom end of the breathing hole being closed with an upper surface of the structure on which the oil pressure control device is mounted.

9. The oil pressure control valve as in claim 1, wherein the oil-retaining space is connected to an oil outlet of the valve body through a drain passage extending downwardly from the oil-retaining space.

10. The oil pressure control valve as in claim 1, wherein the valve member is a spool, and the cylindrical hole is formed in the valve body in a horizontal direction.

11. The oil pressure control valve as in claim 1, wherein the structure on which the oil pressure control valve is to be mounted is an automatic transmission case for an automotive vehicle.

12. The oil pressure control valve as in claim 1, wherein the valve member is driven by an electromagnetic actuator connected to the valve body.
